(19) United States
(12) Patent Application Publication
(10) Pub. No.: US 2026/0142702 A1
(43) Pub. Date: May 21, 2026

(54) CHANNEL AWARE PER LAYER REPORT FOR MULTIPLE-INPUT MULTIPLE-OUTPUT (MIMO) MULTI-LAYER-CODING

(71) Applicant: QUALCOMM Incorporated, San Diego, CA (US)

(72) Inventors: Jacob PICK, Mevaseret Zion (IL); Shay LANDIS, Hod Hasharon (IL); Peer BERGER, Hod Hasharon (IL)

(21) Appl. No.: 18/949,903

(22) Filed: Nov. 15, 2024

(51) Int. Cl. H04B 7/06; H04W 72/231; H04W 72/51

(52) U.S. Cl. CPC H04B 7/0626; H04W 72/231; H04W 72/51

(57) ABSTRACT

Methods, systems, and devices for wireless communications are described. A user equipment (UE) may transmit a capability message, the capability message including an indication of a UE capability for per-layer codeword mapping and a channel state feedback report option. The UE may further receive a channel state feedback configuration that includes an indication of a channel state feedback report type, where the channel state feedback report type is a wideband report, a sub-band report, or a combination thereof. Moreover, the UE transmit a channel state feedback report in accordance with the channel state feedback report option and the channel state feedback report type. Further, the channel state feedback report may be contingent on the UE capability for per-layer codeword mapping and comprising information associated with per layer mutual information.

### FIELD OF TECHNOLOGY

The following relates to wireless communications, including a channel aware per layer report for multiple-input multiple-output (MIMO) multi-layer-coding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication implemented by a user equipment (UE) is described. The method may include transmitting a capability message, the capability message including an indication of a UE capability for per-layer codeword mapping and a channel state feedback (CSF) report option, receiving a CSF configuration that includes an indication of a CSF report type, where the CSF report type is a wideband report, a sub-band report, or a combination thereof, and transmitting a CSF report in accordance with the CSF report option and the CSF report type, the CSF report contingent on the UE capability for per-layer codeword mapping and including information associated with per layer mutual information (MI).

A UE for wireless communication implemented is described. The UE may include one or more memories storing processor executable code, and one or more processors coupled with the one or more memories. The one or more processors may individually or collectively be operable to execute the code to cause the UE to transmit a capability message, the capability message including an indication of a UE capability for per-layer codeword mapping and a CSF report option, receive a CSF configuration that includes an indication of a CSF report type, where the CSF report type is a wideband report, a sub-band report, or a combination thereof, and transmit a CSF report in accordance with the CSF report option and the CSF report type, the CSF report contingent on the UE capability for per-layer codeword mapping and including information associated with per layer MI.

Another UE for wireless communication implemented is described. The UE may include means for transmitting a capability message, the capability message including an indication of a UE capability for per-layer codeword mapping and a CSF report option, means for receiving a CSF configuration that includes an indication of a CSF report type, where the CSF report type is a wideband report, a sub-band report, or a combination thereof, and means for transmitting a CSF report in accordance with the CSF report option and the CSF report type, the CSF report contingent on the UE capability for per-layer codeword mapping and including information associated with per layer MI.

A non-transitory computer-readable medium storing code for wireless communication implemented is described. The code may include instructions executable by one or more processors to transmit a capability message, the capability message including an indication of a UE capability for per-layer codeword mapping and a CSF report option, receive a CSF configuration that includes an indication of a CSF report type, where the CSF report type is a wideband report, a sub-band report, or a combination thereof, and transmit a CSF report in accordance with the CSF report option and the CSF report type, the CSF report contingent on the UE capability for per-layer codeword mapping and including information associated with per layer MI.

In some aspects of the method, UEs, and non-transitory computer-readable medium described herein, the CSF report includes an average per layer MI in accordance with the CSF report option.

Some examples of the method, UEs, and non-transitory computer-readable medium described herein may further include operations, features, means, or instructions for receiving a downlink control information (DCI) that indicates a code rate per layer based on the average per layer MI included in the CSF report.

In some aspects of the method, UEs, and non-transitory computer-readable medium described herein, the CSF report includes code rate per layer information that corresponds to the per layer MI in accordance with the CSF report option.

In some aspects of the method, UEs, and non-transitory computer-readable medium described herein, the code rate per layer information includes a modulation and coding scheme (MCS) that may be reported in the CSF and that may be based on the per layer MI.

Some examples of the method, UEs, and non-transitory computer-readable medium described herein may further include operations, features, means, or instructions for receiving a DCI that indicates a code rate per layer based on the code rate per layer information included in the CSF report.

In some aspects of the method, UEs, and non-transitory computer-readable medium described herein, the CSF report may be initialized with a default per layer MI value.

Some examples of the method, UEs, and non-transitory computer-readable medium described herein may further include operations, features, means, or instructions for calculating an average per layer MI over a slot and determining an average per layer MI calculation based on an average of the average per layer MI over the slot, where the CSF report may be based on the average per layer MI calculation.

In some aspects of the method, UEs, and non-transitory computer-readable medium described herein, the wideband report includes a wideband per layer MI report and the sub-band report includes a sub-band per layer MI report.

In some aspects of the method, UEs, and non-transitory computer-readable medium described herein, the CSF configuration includes an indication of a CSF report periodicity and the CSF report may be transmitted in accordance with the CSF report periodicity.

Some examples of the method, UEs, and non-transitory computer-readable medium described herein may further include operations, features, means, or instructions for receiving an acknowledgment message based on the capability message and performing a radio resource control (RRC) procedure based on the acknowledgment message.

A method for wireless communication implemented by a network entity is described. The method may include receiving a capability message, the capability message including an indication of a UE capability for per-layer codeword mapping and a CSF report option, transmitting a CSF configuration that includes an indication of a CSF report type, where the CSF report type is a wideband report, a sub-band report, or a combination thereof, and receiving a CSF report in accordance with the CSF report option and the CSF report type, the CSF report contingent on the UE capability for per-layer codeword mapping and including information associated with per layer MI.

A network entity for wireless communication implemented is described. The network entity may include one or more memories storing processor executable code, and one or more processors coupled with the one or more memories. The one or more processors may individually or collectively be operable to execute the code to cause the network entity to receive a capability message, the capability message including an indication of a UE capability for per-layer codeword mapping and a CSF report option, transmit a CSF configuration that includes an indication of a CSF report type, where the CSF report type is a wideband report, a sub-band report, or a combination thereof, and receive a CSF report in accordance with the CSF report option and the CSF report type, the CSF report contingent on the UE capability for per-layer codeword mapping and including information associated with per layer MI.

Another network entity for wireless communication implemented is described. The network entity may include means for receiving a capability message, the capability message including an indication of a UE capability for per-layer codeword mapping and a CSF report option, means for transmitting a CSF configuration that includes an indication of a CSF report type, where the CSF report type is a wideband report, a sub-band report, or a combination thereof, and means for receiving a CSF report in accordance with the CSF report option and the CSF report type, the CSF report contingent on the UE capability for per-layer codeword mapping and including information associated with per layer MI.

A non-transitory computer-readable medium storing code for wireless communication implemented is described. The code may include instructions executable by one or more processors to receive a capability message, the capability message including an indication of a UE capability for per-layer codeword mapping and a CSF report option, transmit a CSF configuration that includes an indication of a CSF report type, where the CSF report type is a wideband report, a sub-band report, or a combination thereof, and receive a CSF report in accordance with the CSF report option and the CSF report type, the CSF report contingent on the UE capability for per-layer codeword mapping and including information associated with per layer MI.

In some aspects of the method, network entities, and non-transitory computer-readable medium described herein, the CSF report includes an average per layer MI in accordance with the CSF report option.

Some examples of the method, network entities, and non-transitory computer-readable medium described herein may further include operations, features, means, or instructions for transmitting a DCI that indicates a code rate per layer based on the average per layer MI included in the CSF report.

In some aspects of the method, network entities, and non-transitory computer-readable medium described herein, the CSF report includes code rate per layer information that corresponds to the per layer MI in accordance with the CSF report option.

In some aspects of the method, network entities, and non-transitory computer-readable medium described herein, the code rate per layer information includes a MCS that may be reported in the CSF and that may be based on the per layer MI.

Some examples of the method, network entities, and non-transitory computer-readable medium described herein may further include operations, features, means, or instructions for transmitting a DCI that indicates a code rate per layer based on the code rate per layer information included in the CSF report.

In some aspects of the method, network entities, and non-transitory computer-readable medium described herein, the CSF report may be initialized with a default per layer MI value.

In some aspects of the method, network entities, and non-transitory computer-readable medium described herein, the CSF report may be based on an average per layer MI calculation determined from an average of an average per layer MI over a slot.

In some aspects of the method, network entities, and non-transitory computer-readable medium described herein, the wideband report includes a wideband per layer MI report and the sub-band report includes a sub-band per layer MI report.

In some aspects of the method, network entities, and non-transitory computer-readable medium described herein, the CSF configuration includes an indication of a CSF report periodicity and the CSF report may be transmitted in accordance with the CSF report periodicity.

Some examples of the method, network entities, and non-transitory computer-readable medium described herein may further include operations, features, means, or instructions for transmitting an acknowledgment message based on the capability message and performing a RRC procedure based on the acknowledgment message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show an example of a wireless communications system that supports a channel aware per layer report for multiple-input multiple-output (MIMO) multi-layer-coding in accordance with one or more aspects of the present disclosure.

FIG. 3 shows an example of a process flow that supports a channel aware per layer report for MIMO multi-layer-coding in accordance with one or more aspects of the present disclosure.

FIGS. 4 and 5 show block diagrams of devices that support a channel aware per layer report for MIMO multi-layer-coding in accordance with one or more aspects of the present disclosure.

FIG. 6 shows a block diagram of a communications manager that supports a channel aware per layer report for MIMO multi-layer-coding in accordance with one or more aspects of the present disclosure.

FIG. 7 shows a diagram of a system including a device that supports a channel aware per layer report for MIMO multi-layer-coding in accordance with one or more aspects of the present disclosure.

FIGS. 8 and 9 show block diagrams of devices that support a channel aware per layer report for MIMO multi-layer-coding in accordance with one or more aspects of the present disclosure.

FIG. 10 shows a block diagram of a communications manager that supports a channel aware per layer report for MIMO multi-layer-coding in accordance with one or more aspects of the present disclosure.

FIG. 11 shows a diagram of a system including a device that supports a channel aware per layer report for MIMO multi-layer-coding in accordance with one or more aspects of the present disclosure.

FIGS. 12 and 13 show flowcharts illustrating methods that support a channel aware per layer report for MIMO multi-layer-coding in accordance with one or more aspects of the present disclosure.

### DETAILED DESCRIPTION

In some aspects of a wireless communication system, user equipments (UEs) may be equipped with multiple antennas to support multiple-input multiple-output (MIMO) operations. In one aspect, a UE may use multiple antennas to receive data or transmit data concurrently. Moreover, to ensure reliable communications, the UE may expect to be configured with knowledge of a rate that is achievable for a channel per layer. In one aspect, some channels with separated layers where each layer is independent, a UE may be able to guarantee equal rates between multiple layers or antennas due to lack of inter-layer interference. In one aspect, the lack of inter-layer interference may result in each layer having relatively equal power levels thus enabling a UE to ensure relatively equal rates for each later. In some other channels, layers may have relatively high levels of inter-later interference which may affect an achievable rate per layer. As such, a mutual information (MI) rate of a last layer of a channel may be relatively higher compared to a first layer of the channel resulting in a non-fixed or equal rate between the antenna layers of the UE.

To ensure that the data rates of communications is relatively close to a channel capacity, the techniques of the present disclosure may describe a downlink codeword mapping being changed to be per layer to enable UEs to support a MIMO multi-layer coding (MLC) scheme where each code block may be mapped to a separate layer. Moreover, the techniques of the present disclosure may describe a UE adding a MI per layer indication to a channel state feedback (CSF) report to assist in selecting a per layer rate. In one aspect, in accordance with the techniques of the present disclosure, a UE may transmit a capability message to a network entity that includes an indication of a UE capability for per-layer codeword mapping and a CSF report option. Based on the capability message, the UE may receive a CSF configuration that includes an indication of a wideband CSF report type or a sub-band CSF report type. Further, the UE may transmit a CSF report to the network entity in accordance with the CSF report option and the CSF report type. Moreover, the CSF report may be contingent on the UE capability for per-layer codeword mapping and may include information associated with per-layer MI. Thus, based on a UE supporting MIMO-MLC, in some cases, the UE may transmit an indication of an average MI per layer via the CSF report for the network entity to select a rate to ensure an equal rate for the MIMO-MLC. In some other cases, the UE may select the rate according to a calculated MI and a modulation and coding scheme (MCS) report per layer may be based on the MI per layer. Therefore, the techniques of the present disclosure may enable an increase in throughput by configuring the UE to support MIMO-MLC via a CSF configuration to increase the throughput of communications between UEs and network entities. Moreover, the increase in throughput may be a result of the per layer MI report ensuring an adequate rate per layer.

Aspects of the disclosure are initially described in the context of wireless communications systems. Additional aspects of the disclosure are described with reference to a wireless communications system and a process flow. Aspects of the disclosure are further illustrated by and described with reference to apparatus diagrams, system diagrams, and flowcharts that relate to a channel aware per layer report for MIMO multi-layer-coding.

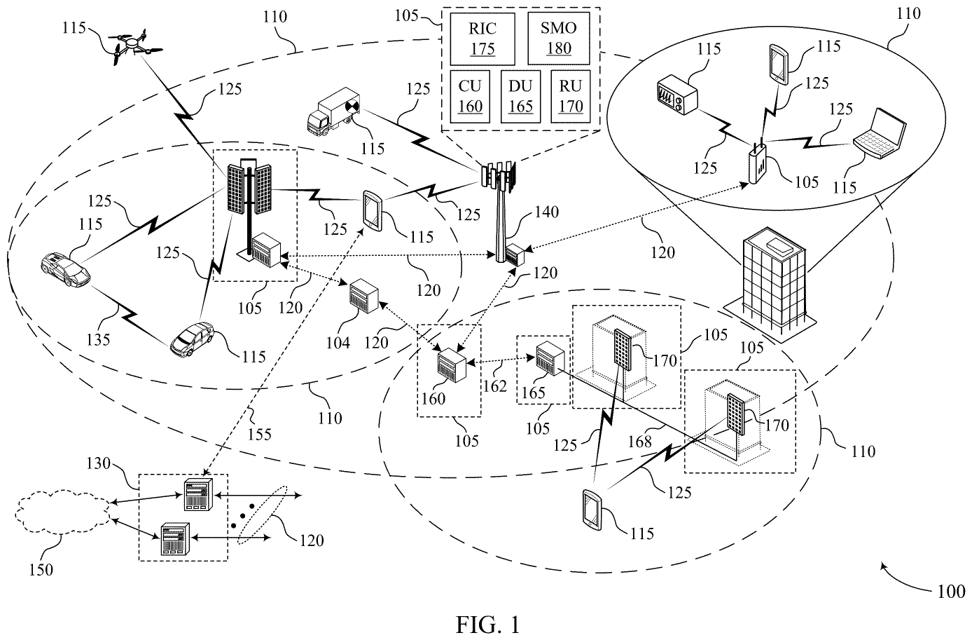

FIG. 1 shows an example of a wireless communications system 100 that supports a channel aware per layer report for MIMO multi-layer-coding in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). In one aspect, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. In one aspect, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. In one aspect, disclosure that a UE 115 is configured to receive information from a network entity 105 also discloses that a first node is configured to receive information from a second node.

In some aspects, network entities 105 may communicate with a core network 130, or with one another, or both. In one aspect, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). In one aspect, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. In one aspect, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support a channel aware per layer report for MIMO multi-layer-coding as described herein. In one aspect, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. In one aspect, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. In one aspect, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some aspects, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. In one aspect, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, In one aspect, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, in one aspect, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. In one aspect, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communications system 100 may include, in one aspect, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. In one aspect, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. In one aspect, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. In one aspect, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, in one aspect, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. In one aspect, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. In one aspect, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some aspects, the beam direction associated with transmissions along a single beam direction may be determined based on a signal that was transmitted along one or more beam directions. In one aspect, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. In one aspect, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other aspects, the device may provide HARQ feedback in a subsequent slot, or according to some other time interval.

In some aspects of the wireless communications system 100, to ensure that data rates of the wireless communications system 100 are relatively close to a channel capacity, the techniques of the present disclosure may describe UEs 115 utilizing a MIMO-MLC scheme. In some cases, the MIMO-MLC scheme may map each code block to a separate layer. Further, in some aspects, using a MIMO-MLC scheme may result in a higher throughput gain for communications between a UE 115 and a network entity 105. In one aspect, in accordance with the techniques of the present disclosure, a UE 115 may transmit a capability message to a network entity 105 that includes an indication of a UE capability for per-layer codeword mapping and a CSF report option. Based on the capability message, the UE 115 may receive a CSF configuration from the network entity 105 that includes an indication of a wideband CSF report type or a sub-band CSF report type. Further, the UE 115 may transmit a CSF report to the network entity 105 in accordance with the CSF report option and the CSF report type. Moreover, the CSF report may be contingent on the UE 115 capability for per-layer codeword mapping and may include information associated with per-layer MI. Thus, based on a UE 115 supporting MIMO-MLC, in some cases, the UE 115 may transmit an indication of an average MI per layer via the CSF report for the network entity to select a rate to ensure that a channel capacity can be achieved when utilizing the MIMO-MLC scheme. In some other cases, the UE 115 may select the rate according to a calculated MI and a modulation and coding scheme (MCS) report per layer may be based on the MI per layer. Therefore, the techniques of the present disclosure may enable an increase in throughput by a network entity 105 configuring a UE 115 to support MIMO-MLC via a CSF configuration. Moreover, the increase in throughput may be a result of the per layer MI report ensuring an adequate rate per layer.

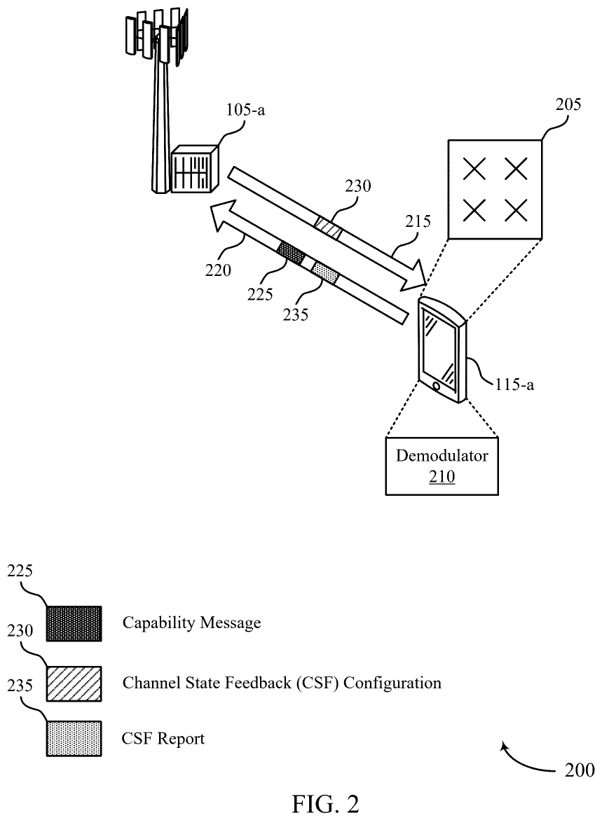

FIG. 2 shows an example of a wireless communications system 200 that supports a channel aware per layer report for MIMO multi-layer-coding in accordance with one or more aspects of the present disclosure. In some aspects, the wireless communications system 200 may implement or be implemented by the wireless communications system 100. In one aspect, the wireless communications system 200 may include a network entity 105-a and a UE 115-a configured with an antenna panel 205 and a demodulator 210, which may represent examples of corresponding devices described herein with reference to FIG. 1. The network entity 105-a may communicate with the UE 115-a via a downlink communication link 215 and the UE 115-a may communicate with the network entity 105-a via an uplink communication link 220. The downlink communication link 215 and the uplink communication link 220 may be examples of a Uu link, a sidelink, a backhaul link, a D2D link or some other type of communication link 125 described herein with reference to FIG. 1.

In some aspects, the UE 115-a may be configured with the antenna panel 205 that has one or more antenna ports (e.g., physical antenna elements). In some cases, the UE 115-a may support MIMO communications via one or more MIMO layers. A MIMO layer may refer to a data stream transmitted or received via the antenna ports of the antenna panel 205 at the UE 115-a. In one aspect, if each antenna port of the antenna panel 205 is capable of transmitting and receiving data separately and the antenna panel 205 of the UE 115-a has four antenna ports, as illustrated herein, the UE 115-a may be capable of supporting four MIMO layers (e.g., four parallel data streams). Thus, a quantity of MIMO layers may refer to a quantity of parallel data streams that the UE 115-a is capable of transmitting, receiving, or both. However, it should be understood by one having ordinary skill in the art that a UE 115 may have any quantity of antenna ports and can be capable of supporting any quantity of MIMO layers.

Further, in some cases, the UE 115-a and the network entity 105-a may communicate via one or more MIMO channels. In one aspect, a first MIMO channel may be an additive white Gaussian noise (AWGN) channel or some other type of diagonal fading channel (e.g., a channel with a lack of cross-layer interference or correlation) and a second MIMO channel may be a high correlation fading channel (e.g., a channel with a relatively large cross-layer interference or correlation). In the first MIMO layer, due to the lack of interference or correlation between the layers, the rates of each layer may be equal. In the second MIMO layer, each layer may share or exchange a relatively large quantity of information with a subsequent layer such that a MI rate of a last layer may be relatively higher compared than a MI rate of a first layer. Thus, the UE 115-a and the network entity 105-a may be unable to use a fixed rate allocation for the MIMO scheme.

Therefore, in some aspects, the UE 115-a and the network entity 105-a may utilize a MIMO-MLC configuration or scheme, in accordance with the techniques of the present disclosure, to ensure an average rate allocation between layers on a MIMO channel. Further, in some cases, a MIMO-MLC scheme may be capacity achieving and may result in a throughput gain compared to non MIMO-MLC schemes. Moreover, while other communication schemes (e.g., turbo equalization) can be used to improve the throughput of the wireless communications system 200, such schemes may be relatively more complex and power consuming than MIMO-MLC. However, to ensure reliable communications within the wireless communications system 200, the UE 115-a may expect to obtain knowledge of the channel aware achievable rate per layer.

In the MIMO-MLC configuration each code block may be mapped to a layer and the demodulator 210 may perform the demodulation of each layer given the knowledge of the symbols of a previous layer (e.g., after or based on detection of the previous layer). Further, the demodulator 210 (e.g., a MIMO-MLC demodulator) may have a hypothesis space for all the layers. In one aspect, the demodulator 210 may generate a hypothesis space to guess or hypothesize the symbols transmitted in all the layers. Moreover, once a layer is detected, the UE 115-a may detect elements within the hypothesis space that are different from the pre-detected symbols of the previous layers. Thus, when detecting layer 2 after layer 1 is detected, the demodulator 210 of the UE 115-a may remove any hypothesis from the hypothesis space that is different from the symbols that the demodulator 210 detects for layer 1. Therefore, a Euclidian distance of the hypothesis vector with the detected previous layers to a vector of a received signal may be relatively smaller thus resulting in an increase of a log-likelihood ratio (LLR) size. Further, as a current detected layer may gain from previous layers detection by removing incorrect hypothesis from the hypothesis space, the MIMO-MLC scheme may improve the overall confidence of a belief propagation based decoder. Additionally, or alternatively, as the LLRs of the layers may increase in size, a block error rate (BLER) may improve (e.g., decrease) for the current layer as well by having information about previously detected layers. Moreover, having the UE 115-a utilize the MIMO-MLC scheme may result in an increase in throughput (e.g., a 2.5 dB throughput gain compared to utilizing a non-MIMO-MLC scheme) and communication efficiency within the wireless communications system 200 due to removing hypotheses associated with the detected layers.

Further, as described herein, the MIMO-MLC scheme may be capacity achieving and may impact the rate of each layer. In one aspect, the MI between a transmitted symbols vector, \vec{x}, and a received signal vector, \vec{y}, may be shown via Equation 1 by writing the expression using the chain rule for MI.

$$I ( \vec{x} ; \vec{y} ) = {\sum }_{i = 1}^{{N}_{layers}} I ( {x}_{i} ; \vec{y} \vert {x}_{i - 1} , {x}_{i - 2} , ⋯ , {x}_{1} ) \qquad ( 1 )$$

In some aspects, since the i′th term, I(xᵢ;\vec{y}|xᵢ₋₁, xᵢ₋₂, . . . , x₁) may represent the MI of layer i symbol within the received signal given the previous layers symbols, the i′th term may be interpreted as a demodulation of layer i of MIMO-MLC given the previous layers detected symbols. Thus, MIMO-MLC may be referred to as a capacity preserving scheme. Further, at stage i, the MI of the MIMO-MLC may be given by, I(xᵢ;\vec{y}|xᵢ₋₁, xᵢ₋₂, . . . , x₁) and that for a reliable reception of layer i the code rate may be expected to be less or equal to the MI of that layer with respect to given the previously detected layers, as shown in Equation 2.

$${R}_{i} \leq I ( {x}_{i} ; \vec{y} \vert {x}_{i - 1} , {x}_{i - 2} , ⋯ , {x}_{1} ) \qquad ( 2 )$$

That is, if a reliable reception is to be maintained, the UE 115-a should refrain from transmitting at a layer that is higher than the MI. The UE 115-a may transmit at a lower rate, however such transmission may result in a reduction in capacity. Thus, the UE 115-a may attempt to use a rate of transmission that is relatively close to the MI. However, it may be relatively difficult for the UE 115-a and the network entity 105-a to select a rate for a respective layer without knowledge of the MI for the respective layer. Thus, the MI of layer i may be a crucial parameter for determining a code rate of layer i. Therefore, since the parameter may be channel dependent, the techniques of the present disclosure may describe the UE 115-a reporting the channel aware MI per layer to enable an improved MIMO-MLC scheme to be utilized in the wireless communications system 200.

In some aspects, in accordance with the techniques of the present disclosure, a channel aware MI report handshake may occur between the UE 115-a and the network entity 105-a. Further, the UE 115-a and the network entity 105-a may assume that the MI per layer changes relatively slowly and relative to a slot rate. In one aspect, if the rate changes rapidly (e.g., at a higher rate than the slot rate), reports from the UE 115-a may be invalid by the time the network entity 105-a receives the reports due to the relatively quickly due to the rapidly changing conditions. In some aspects, prior to transmitting a report, the UE 115-a may transmit a capability message 225 including an indication of UE 115 capability for per-layer codeword mapping and a CSF report option. In response, the UE 115-a may receive a CSF configuration 230 that includes an indication of a CSF report type where the CSF report type can be a wideband report, a sub-band report, or a combination thereof. In one aspect, the UE 115-a may be configured to transmit a CSF report 235 that is wideband CSF report 235 that includes a wideband MI per layer report or a sub-band CSF report 235 includes a sub-band MI per layer report.

In some cases, to transmit MI per layer reports, the UE 115-a may initialize an MI per layer report with a default value (e.g., an equal rate value). In one aspect, the CSF configuration 230 from the network entity 105-a may configure the UE 115-a with a default value for initializing the MI per layer reports or the UE 115-a may select or determine the default value. Further, during a current slot, after receiving the LLRs for each layer, the UE 115-a may calculate an average per layer MI over the slot. Moreover, using the average per layer MI, the UE 115-a may average the MI with previous calculated MIs. That is, the UE 115-a may determine an average per layer MI calculation based on an average of the average per layer MI over the slot.

In some aspects, the UE 115-a may transmit a specific report of the average MI per layer and add the report to a CSF report 235. In such cases, the network entity 105-a may be capable of deciding based on a margin from the MI for setting the rate. However, an additional field may have to be added to the CSF report 235 thus increasing the complexity of generating the CSF report 235 and the signaling overhead of the CSF report 235. Further, in such examples, the network entity 105-a may receive the CSF report 235 and set the rate per layer to be as close as possible (e.g., or below) to the MI of the layer. Additionally, or alternatively, the network entity 105-a may add some backoff to the rate to account for receiver imperfections.

In some other aspects, rather than adding the average MI per layer to the CSF report 235, the UE 115-a may select a rate per layer according to the calculated MI and a MCS report per layer may reflect the MI per layer. Thus, the UE 115-a may prevent increasing the complexity and signaling overhead of the CSF report 235. However, the network entity 105-a may be unable to decide based on a margin from the MI for setting the rate. Moreover, the CSF report 235 may include code rate per layer information that corresponds to the per layer MI in accordance with CSF report option indicated in the CSF configuration 230 and the code rate per layer information may include an MCS that is reported in the CSF report 235 based on the per layer MI. Thus, the UE 115-a may report a recommendation of an MCS per layer in the CSF report 235 using the per layer MI calculations and the network entity 105-a may set the recommended MCS per layer based on the indication or request from the UE 115-a.

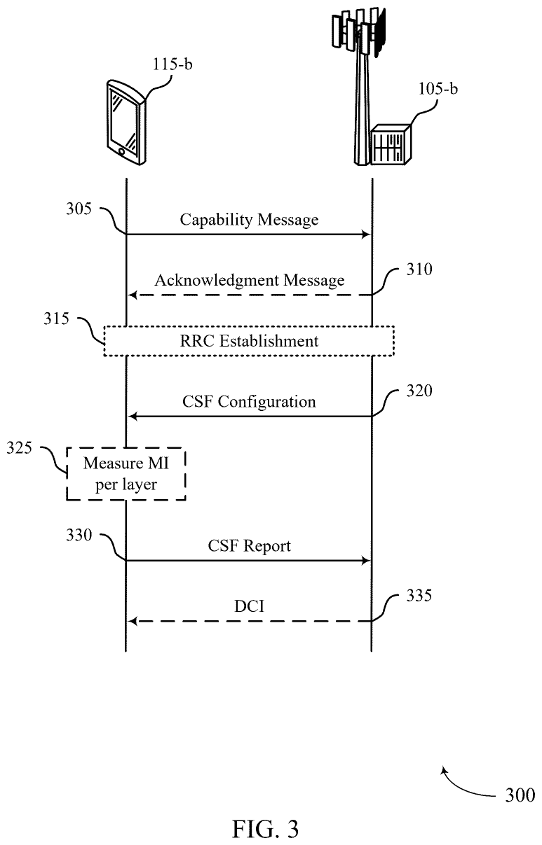

Thus, the techniques of the present disclosure may enable channel aware MI reports within CSF reports 235 to improve the use of a MIMO-MLC scheme. Further description of the techniques of the present disclosure may be described elsewhere herein, such as with reference to FIG. 3. In one aspect, FIG. 3 may illustrate a process flow between a UE 115 and a network entity 105 that describes the techniques of the present disclosure in view of an RRC establishment procedure.

FIG. 3 shows an example of a process flow 300 that supports a channel aware per layer report for MIMO multi-layer-coding in accordance with one or more aspects of the present disclosure. In some aspects, the process flow 300 may implement or may be implemented by the wireless communications system 100, the wireless communications system 200, or both. The process flow 300 may include a UE 115-b and a network entity 105-b, which may be examples of devices or services described elsewhere herein including with reference to FIG. 1.

In the following description of the process flow 300, the operations may be performed by the UE 115-b and the network entity 105-b, in different orders or at different times. Some operations may also be left out of the process flow 300, or other operations may be added. Although the process flow 300 may be described as being performed by the UE 115-b and the network entity 105-b, some aspects of some operations may also be performed by other devices, services, or models described elsewhere herein including with reference to FIGS. 1 through 2.

At 305, the UE 115-b may transmit, to the network entity 105-b, a capability message that includes an indication of a UE 115 capability for per-layer codeword mapping and a CSF report option. In some cases, the per-layer codeword mapping capability indication may be a single bit indication. Further, the indication may be a single codeword for all layers up to rank 4 and two codewords for ranks above rank 4. Moreover, if the capability message indicates a per-layer codeword, the capability message may also include a one-bit CSF report option. A first report option may be that the UE 115-b is capable of adding an additional per layer MI field to the CSF report and a second report option may be that the MI will be reflected by the per code rate selection by the UE 115-b. In some cases, the UE 115-b may select the second report option due to the UE 115-b being incapable of adding an additional field to the CSF report, to prevent an increase in complexity and signaling overhead associated with the CSF report, or a combination thereof.

At 310, the UE 115-b may receive, from the network entity 105-b, and acknowledgement message based on the capability message from the UE 115-b. Further, at 315, the network entity 105-b and the UE 115-b may perform an RRC procedure in response to and based on the acknowledgment message. In one aspect, the network entity 105-b and the UE 115-b may perform an RRC establishment procedure to establish an RRC connection between the network entity 105-b and the UE 115-b.

At 320, the UE 115-b may receive, from the network entity 105-b, a CSF configuration that includes an indication of a CSF report type. Moreover, the CSF report type may be a wideband report, a sub-band report, or a combination thereof. Further, in some cases, the wideband report may include a wideband per layer MI report and the sub-band report may include a sub-band per layer MI report. Additionally, or alternatively, the CSF configuration may include an indication of a CSF report periodicity where the UE 115-b may transmit the CSF report in accordance with the CSF report periodicity.

At 325, In some aspects, the UE 115-b may calculate an average per layer MI over a slot and determine an average per layer MI calculation based on an average of the average per layer MI over the slot such that a CSF report is based on the average per layer MI calculation. Further, the UE 115-b may calculate the average MI per layer per wideband or per sub-band in accordance with a message type (e.g., the CSF report type). Based on the calculations, at 330, the UE 115-b may transmit, to the network entity 105-b, a CSF report in accordance with the CSF report option and the CSF report type. Further, the CSF report may be contingent on the UE 115 capability for per-layer codeword mapping. Moreover, the CSF report may include information associated with per layer MI. In one aspect, the CSF report may include an average per layer MI in accordance with the CSF report option. Further, the CSF report may include code rate per layer information that corresponds to per layer MI in accordance with the CSF report option. Moreover, the code rate per layer information may include a MCS that is reported in the CSF report and is based on the per layer MI. Additionally, or alternatively, the CSF report may be initialized with a default per layer MI value before the calculating the average per layer MI over a slot and determining the average per layer MI calculation. Therefore, in some aspects, the UE 115-b may add a wideband MI report per layer or a sub-band MI report per layer to the CSF report. In some other aspects, the UE 115-b may set the rate in the CSF report for the wideband or for the sub-band via an MCS that accounts for the MI per layer.

At 335, the UE 115-b may receive, from the network entity 105-b, a downlink control information (DCI) message that indicates a code rate per layer. In some cases, the code rate per layer may be based on the average per layer MI included in the CSF report. In one aspect, the network entity 105-b may select the code rate per layer with a margin with respect to the MI per layer reported by the UE 115-b via the CSF report. In some other cases, the code rate per layer may be based on the code rate per layer information included in the CSF report. In one aspect, based on the code rate per layer that the UE 115-b recommends and reports via the CSF report, the network entity 105-b may set the code rate per layer accordingly.

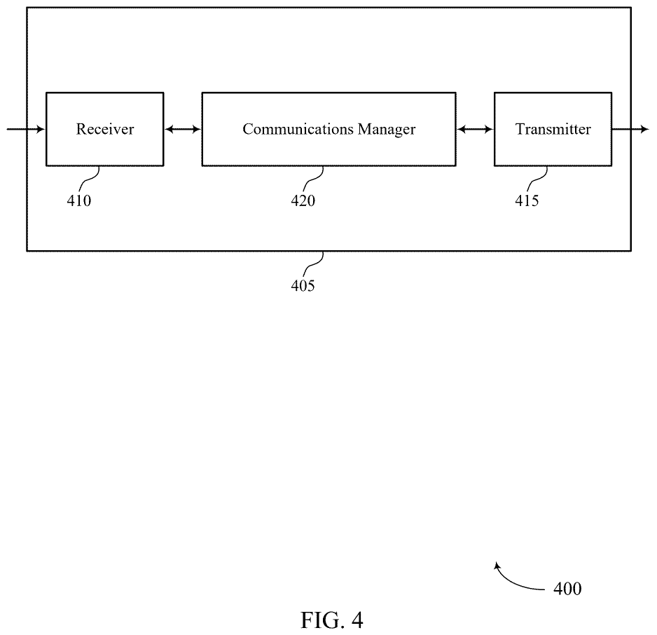

Therefore, in accordance with the techniques of the present disclosure, communications between the UE 115-b and the network entity 105-b may have an increase in throughput. In one aspect, supporting MIMO-MLC and enabling the UE 115-b to transmit the per layer MI based report may enable reliable communications with a relatively accurate rate per layer which can result in an increase in throughput, efficiency, and reliability for a wireless communications system (e.g., the wireless communications system 100, the wireless communications system 200, or both). Further descriptions of the techniques of the present disclosure may be described elsewhere herein, such as with reference to FIGS. 4 through 13.

FIG. 4 shows a block diagram 400 of a device 405 that supports a channel aware per layer report for MIMO multi-layer-coding in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to a channel aware per layer report for MIMO multi-layer-coding). Information may be passed on to other components of the device 405. The receiver 410 may utilize a single antenna or a set of multiple antennas.

The transmitter 415 may provide a means for transmitting signals generated by other components of the device 405. In one aspect, the transmitter 415 may transmit information such as packets, user data, control information, or any combination thereof associated with various information channels (e.g., control channels, data channels, information channels related to a channel aware per layer report for MIMO multi-layer-coding). In some aspects, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of a channel aware per layer report for MIMO multi-layer-coding as described herein. In one aspect, the communications manager 420, the receiver 410, the transmitter 415, or various combinations or components thereof may be capable of performing one or more of the functions described herein.

In some aspects, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 420 may be configured to perform various operations (e.g., receiving, obtaining, monitoring, outputting, transmitting) using or otherwise in cooperation with the receiver 410, the transmitter 415, or both. In one aspect, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication implemented in accordance with examples as disclosed herein. In one aspect, the communications manager 420 is capable of, configured to, or operable to support a means for transmitting a capability message, the capability message including an indication of a UE capability for per-layer codeword mapping and a channel state feedback (CSF) report option. The communications manager 420 is capable of, configured to, or operable to support a means for receiving a CSF configuration that includes an indication of a CSF report type, where the CSF report type is a wideband report, a sub-band report, or a combination thereof. The communications manager 420 is capable of, configured to, or operable to support a means for transmitting a CSF report in accordance with the CSF report option and the CSF report type, the CSF report contingent on the UE capability for per-layer codeword mapping and including information associated with per layer mutual information (MI).

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for enabling a per layer MI report to support reduced processing, reduced power consumption, and more efficient utilization of communication resources.

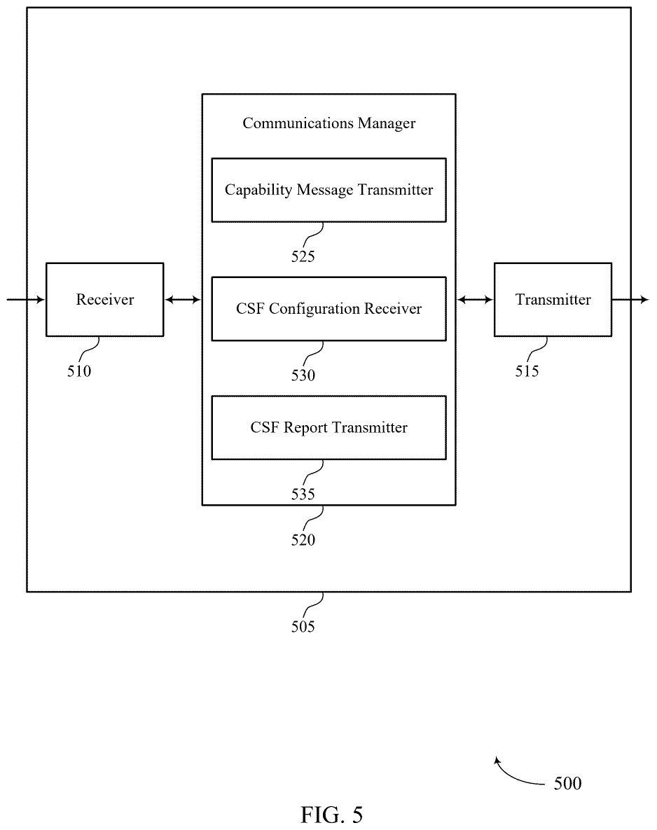

FIG. 5 shows a block diagram 500 of a device 505 that supports a channel aware per layer report for MIMO multi-layer-coding in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to a channel aware per layer report for MIMO multi-layer-coding). Information may be passed on to other components of the device 505. The receiver 510 may utilize a single antenna or a set of multiple antennas.

The transmitter 515 may provide a means for transmitting signals generated by other components of the device 505. In one aspect, the transmitter 515 may transmit information such as packets, user data, control information, or any combination thereof associated with various information channels (e.g., control channels, data channels, information channels related to a channel aware per layer report for MIMO multi-layer-coding). In some aspects, the transmitter 515 may be co-located with a receiver 510 in a transceiver module. The transmitter 515 may utilize a single antenna or a set of multiple antennas.

The device 505, or various components thereof, may be an example of means for performing various aspects of a channel aware per layer report for MIMO multi-layer-coding as described herein. In one aspect, the communications manager 520 may include a capability message transmitter 525, an CSF configuration receiver 530, an CSF report transmitter 535, or any combination thereof. The communications manager 520 may be an example of aspects of a communications manager 420 as described herein. In some aspects, the communications manager 520, or various components thereof, may be configured to perform various operations (e.g., receiving, obtaining, monitoring, outputting, transmitting) using or otherwise in cooperation with the receiver 510, the transmitter 515, or both. In one aspect, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication implemented in accordance with examples as disclosed herein. The capability message transmitter 525 is capable of, configured to, or operable to support a means for transmitting a capability message, the capability message including an indication of a UE capability for per-layer codeword mapping and a channel state feedback (CSF) report option. The CSF configuration receiver 530 is capable of, configured to, or operable to support a means for receiving a CSF configuration that includes an indication of a CSF report type, where the CSF report type is a wideband report, a sub-band report, or a combination thereof. The CSF report transmitter 535 is capable of, configured to, or operable to support a means for transmitting a CSF report in accordance with the CSF report option and the CSF report type, the CSF report contingent on the UE capability for per-layer codeword mapping and including information associated with per layer mutual information (MI).

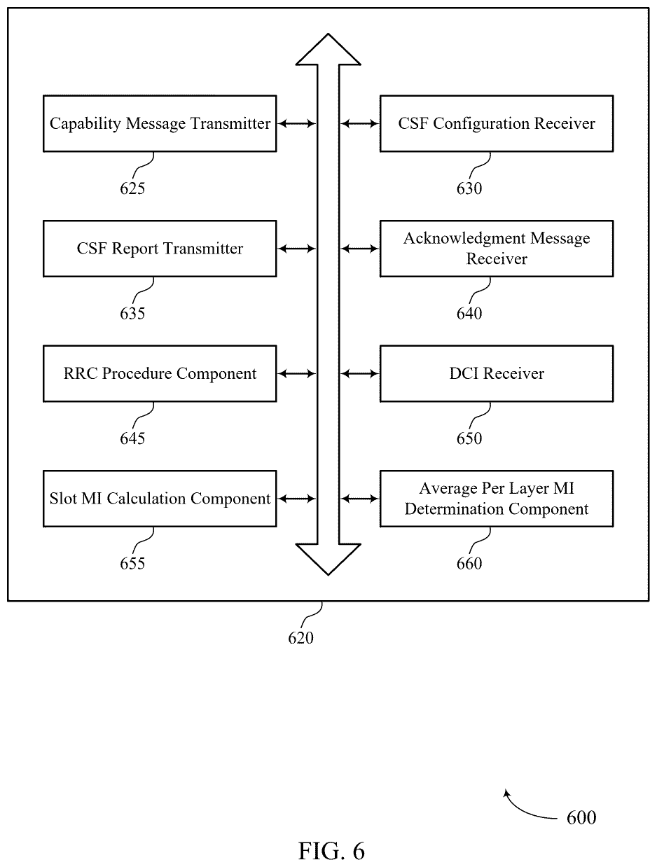

FIG. 6 shows a block diagram 600 of a communications manager 620 that supports a channel aware per layer report for MIMO multi-layer-coding in accordance with one or more aspects of the present disclosure. The communications manager 620 may be an example of aspects of a communications manager 420, a communications manager 520, or both, as described herein. The communications manager 620, or various components thereof, may be an example of means for performing various aspects of a channel aware per layer report for MIMO multi-layer-coding as described herein. In one aspect, the communications manager 620 may include a capability message transmitter 625, an CSF configuration receiver 630, an CSF report transmitter 635, an acknowledgment message receiver 640, an RRC procedure component 645, a DCI receiver 650, a slot MI calculation component 655, an average per layer MI determination component 660, or any combination thereof. Each of these components, or components or subcomponents thereof (e.g., one or more processors, one or more memories), may communicate, directly or indirectly, with one another (e.g., via one or more buses).

The communications manager 620 may support wireless communication implemented in accordance with examples as disclosed herein. The capability message transmitter 625 is capable of, configured to, or operable to support a means for transmitting a capability message, the capability message including an indication of a UE capability for per-layer codeword mapping and a channel state feedback (CSF) report option. The CSF configuration receiver 630 is capable of, configured to, or operable to support a means for receiving a CSF configuration that includes an indication of a CSF report type, where the CSF report type is a wideband report, a sub-band report, or a combination thereof. The CSF report transmitter 635 is capable of, configured to, or operable to support a means for transmitting a CSF report in accordance with the CSF report option and the CSF report type, the CSF report contingent on the UE capability for per-layer codeword mapping and including information associated with per layer mutual information (MI).

In some aspects, the CSF report includes an average per layer MI in accordance with the CSF report option.

In some aspects, the DCI receiver 650 is capable of, configured to, or operable to support a means for receiving a DCI that indicates a code rate per layer based on the average per layer MI included in the CSF report.

In some aspects, the CSF report includes code rate per layer information that corresponds to the per layer MI in accordance with the CSF report option.

In some aspects, the code rate per layer information includes a modulation and coding scheme that is reported in the CSF report and that is based on the per layer MI.

In some aspects, the DCI receiver 650 is capable of, configured to, or operable to support a means for receiving a DCI that indicates a code rate per layer based on the code rate per layer information included in the CSF report.

In some aspects, the CSF report is initialized with a default per layer MI value.

In some aspects, the slot MI calculation component 655 is capable of, configured to, or operable to support a means for calculating an average per layer MI over a slot. In some aspects, the average per layer MI determination component 660 is capable of, configured to, or operable to support a means for determining an average per layer MI calculation based on an average of the average per layer MI over the slot, where the CSF report is based on the average per layer MI calculation.

In some aspects, the wideband report includes a wideband per layer MI report. In some aspects, the sub-band report includes a sub-band per layer MI report.

In some aspects, the CSF configuration includes an indication of a CSF report periodicity. In some aspects, the CSF report is transmitted in accordance with the CSF report periodicity.

In some aspects, the acknowledgment message receiver 640 is capable of, configured to, or operable to support a means for receiving an acknowledgment message based on the capability message. In some aspects, the RRC procedure component 645 is capable of, configured to, or operable to support a means for performing a radio resource control procedure based on the acknowledgment message.

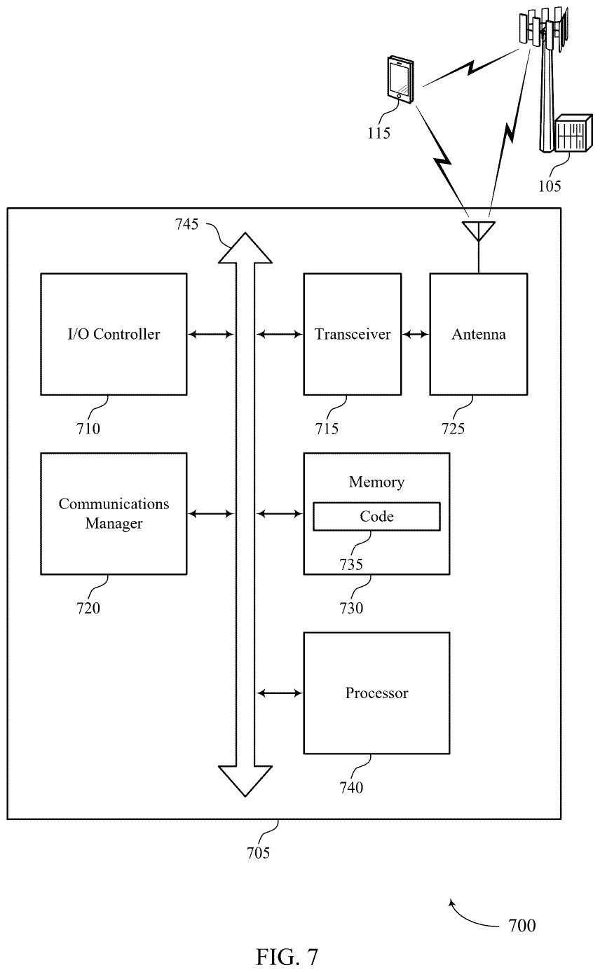

FIG. 7 shows a diagram of a system 700 including a device 705 that supports a channel aware per layer report for MIMO multi-layer-coding in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. In one aspect, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting a channel aware per layer report for MIMO multi-layer-coding). In one aspect, the device 705 or a component of the device 705 may include at least one processor 740 and at least one memory 730 coupled with or to the at least one processor 740, the at least one processor 740 and the at least one memory 730 configured to perform various functions described herein.

In some aspects, the at least one processor 740 may include multiple processors and the at least one memory 730 may include multiple memories. One or more of the multiple processors may be coupled with one or more of the multiple memories, which may, individually or collectively, be configured to perform various functions described herein. In some aspects, the at least one processor 740 may be a component of a processing system, which may refer to a system (such as a series) of machines, circuitry (including, In one aspect, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. In one aspect, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication implemented in accordance with examples as disclosed herein. In one aspect, the communications manager 720 is capable of, configured to, or operable to support a means for transmitting a capability message, the capability message including an indication of a UE capability for per-layer codeword mapping and a channel state feedback (CSF) report option. The communications manager 720 is capable of, configured to, or operable to support a means for receiving a CSF configuration that includes an indication of a CSF report type, where the CSF report type is a wideband report, a sub-band report, or a combination thereof. The communications manager 720 is capable of, configured to, or operable to support a means for transmitting a CSF report in accordance with the CSF report option and the CSF report type, the CSF report contingent on the UE capability for per-layer codeword mapping and including information associated with per layer mutual information (MI).

By including or configuring the communications manager 720 in accordance with examples as described herein, the device 705 may support techniques for enabling a per layer MI report to support improved communication reliability, reduced latency, improved user experience related to reduced processing, reduced power consumption, more efficient utilization of communication resources, improved coordination between devices, longer battery life, and improved utilization of processing capability.

In some aspects, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, In some aspects, one or more functions described with reference to the communications manager 720 may be supported by or performed by the at least one processor 740, the at least one memory 730, the code 735, or any combination thereof. In one aspect, the code 735 may include instructions executable by the at least one processor 740 to cause the device 705 to perform various aspects of a channel aware per layer report for MIMO multi-layer-coding as described herein, or the at least one processor 740 and the at least one memory 730 may be otherwise configured to, individually or collectively, perform or support such operations.

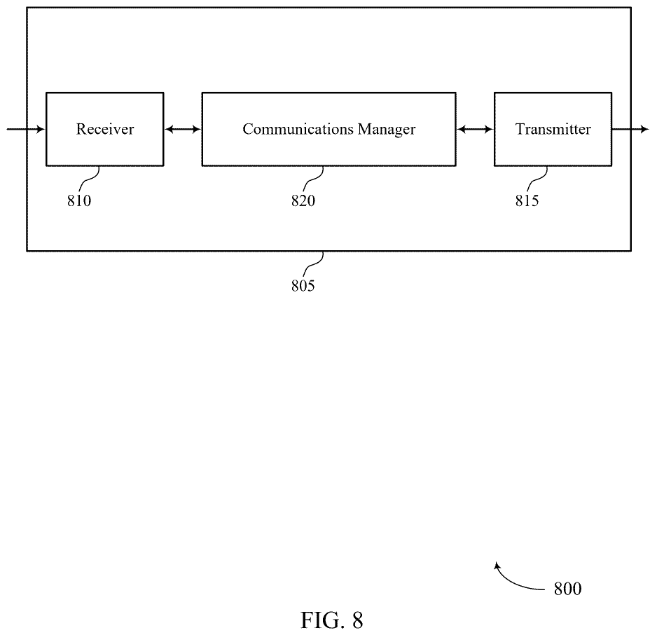

FIG. 8 shows a block diagram 800 of a device 805 that supports a channel aware per layer report for MIMO multi-layer-coding in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some aspects, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. In one aspect, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some aspects, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of a channel aware per layer report for MIMO multi-layer-coding as described herein. In one aspect, the communications manager 820, the receiver 810, the transmitter 815, or various combinations or components thereof may be capable of performing one or more of the functions described herein.

In some aspects, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 820 may be configured to perform various operations (e.g., receiving, obtaining, monitoring, outputting, transmitting) using or otherwise in cooperation with the receiver 810, the transmitter 815, or both. In one aspect, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication implemented in accordance with examples as disclosed herein. In one aspect, the communications manager 820 is capable of, configured to, or operable to support a means for receiving a capability message, the capability message including an indication of a UE capability for per-layer codeword mapping and a channel state feedback (CSF) report option. The communications manager 820 is capable of, configured to, or operable to support a means for transmitting a CSF configuration that includes an indication of a CSF report type, where the CSF report type is a wideband report, a sub-band report, or a combination thereof. The communications manager 820 is capable of, configured to, or operable to support a means for receiving a CSF report in accordance with the CSF report option and the CSF report type, the CSF report contingent on the UE capability for per-layer codeword mapping and including information associated with per layer mutual information (MI).

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for enabling a per layer MI report to support reduced processing, reduced power consumption, and more efficient utilization of communication resources.

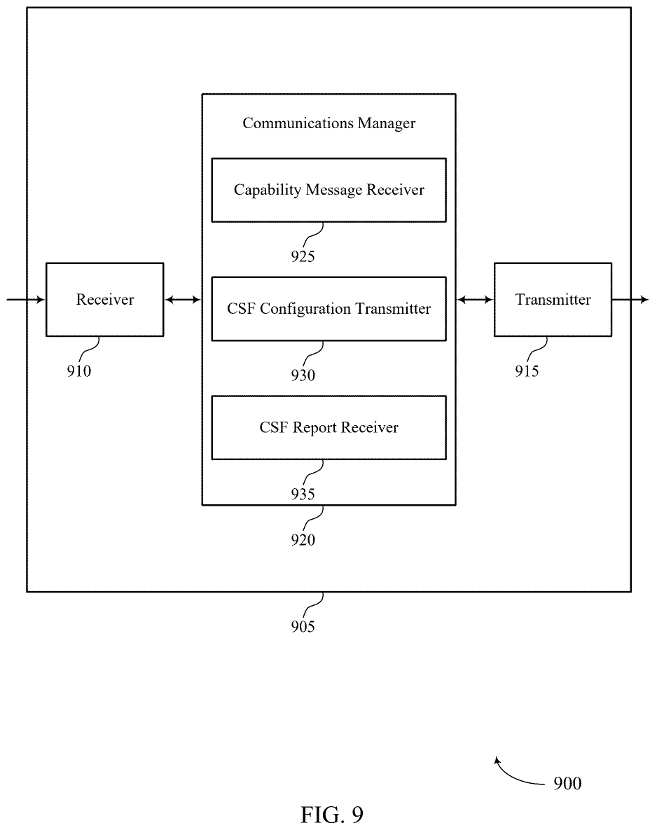

FIG. 9 shows a block diagram 900 of a device 905 that supports a channel aware per layer report for MIMO multi-layer-coding in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some aspects, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. In one aspect, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some aspects, the transmitter 915 and the receiver 910 may be co-located in a transceiver, which may include or be coupled with a modem.

The device 905, or various components thereof, may be an example of means for performing various aspects of a channel aware per layer report for MIMO multi-layer-coding as described herein. In one aspect, the communications manager 920 may include a capability message receiver 925, an CSF configuration transmitter 930, an CSF report receiver 935, or any combination thereof. The communications manager 920 may be an example of aspects of a communications manager 820 as described herein. In some aspects, the communications manager 920, or various components thereof, may be configured to perform various operations (e.g., receiving, obtaining, monitoring, outputting, transmitting) using or otherwise in cooperation with the receiver 910, the transmitter 915, or both. In one aspect, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication implemented in accordance with examples as disclosed herein. The capability message receiver 925 is capable of, configured to, or operable to support a means for receiving a capability message, the capability message including an indication of a UE capability for per-layer codeword mapping and a channel state feedback (CSF) report option. The CSF configuration transmitter 930 is capable of, configured to, or operable to support a means for transmitting a CSF configuration that includes an indication of a CSF report type, where the CSF report type is a wideband report, a sub-band report, or a combination thereof. The CSF report receiver 935 is capable of, configured to, or operable to support a means for receiving a CSF report in accordance with the CSF report option and the CSF report type, the CSF report contingent on the UE capability for per-layer codeword mapping and including information associated with per layer mutual information (MI).

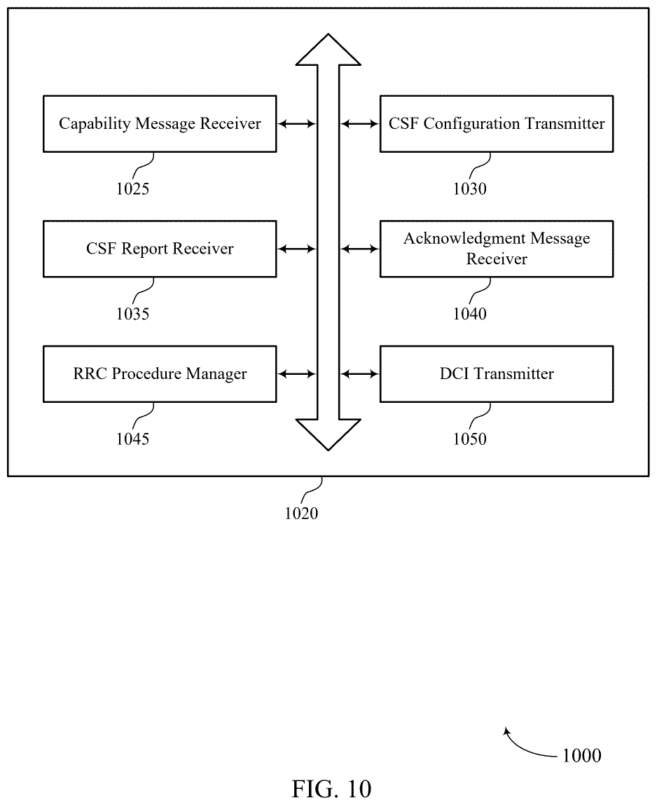

FIG. 10 shows a block diagram 1000 of a communications manager 1020 that supports a channel aware per layer report for MIMO multi-layer-coding in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of a channel aware per layer report for MIMO multi-layer-coding as described herein. In one aspect, the communications manager 1020 may include a capability message receiver 1025, an CSF configuration transmitter 1030, an CSF report receiver 1035, an acknowledgment message receiver 1040, an RRC procedure manager 1045, a DCI transmitter 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication implemented in accordance with examples as disclosed herein. The capability message receiver 1025 is capable of, configured to, or operable to support a means for receiving a capability message, the capability message including an indication of a UE capability for per-layer codeword mapping and a channel state feedback (CSF) report option. The CSF configuration transmitter 1030 is capable of, configured to, or operable to support a means for transmitting a CSF configuration that includes an indication of a CSF report type, where the CSF report type is a wideband report, a sub-band report, or a combination thereof. The CSF report receiver 1035 is capable of, configured to, or operable to support a means for receiving a CSF report in accordance with the CSF report option and the CSF report type, the CSF report contingent on the UE capability for per-layer codeword mapping and including information associated with per layer mutual information (MI).

In some aspects, the CSF report includes an average per layer MI in accordance with the CSF report option.

In some aspects, the DCI transmitter 1050 is capable of, configured to, or operable to support a means for transmitting a DCI that indicates a code rate per layer based on the average per layer MI included in the CSF report.

In some aspects, the CSF report includes code rate per layer information that corresponds to the per layer MI in accordance with the CSF report option.

In some aspects, the code rate per layer information includes a modulation and coding scheme that is reported in the CSF report and that is based on the per layer MI.

In some aspects, the DCI transmitter 1050 is capable of, configured to, or operable to support a means for transmitting a DCI that indicates a code rate per layer based on the code rate per layer information included in the CSF report.

In some aspects, the CSF report is initialized with a default per layer MI value.

In some aspects, the CSF report is based on an average per layer MI calculation determined from an average of an average per layer MI over a slot.

In some aspects, the wideband report includes a wideband per layer MI report. In some aspects, the sub-band report includes a sub-band per layer MI report.

In some aspects, the CSF configuration includes an indication of a CSF report periodicity. In some aspects, the CSF report is transmitted in accordance with the CSF report periodicity.

In some aspects, the acknowledgment message receiver 1040 is capable of, configured to, or operable to support a means for transmitting an acknowledgment message based on the capability message. In some aspects, the RRC procedure manager 1045 is capable of, configured to, or operable to support a means for performing a radio resource control procedure based on the acknowledgment message.

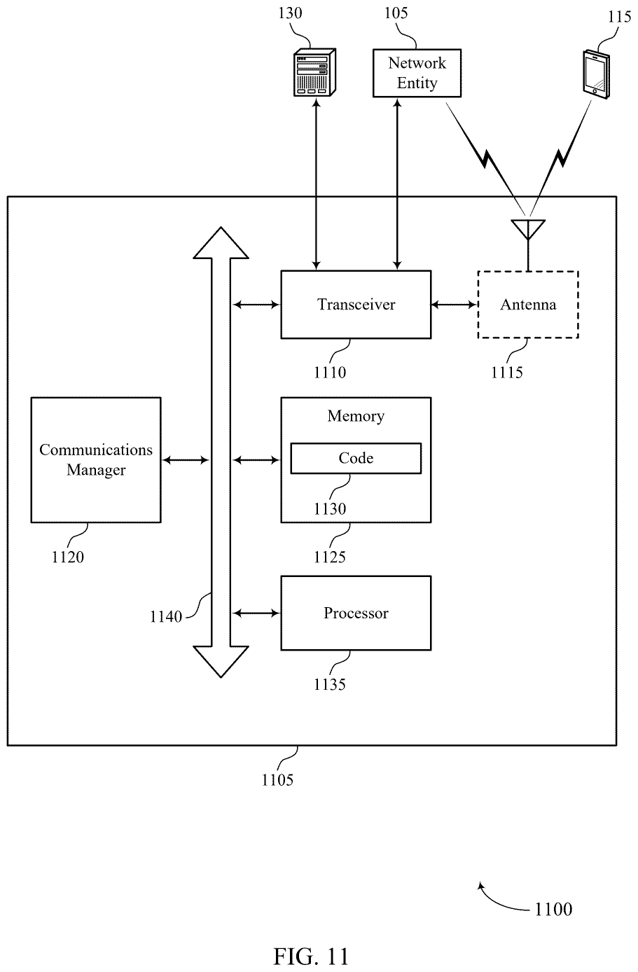

FIG. 11 shows a diagram of a system 1100 including a device 1105 that supports a channel aware per layer report for MIMO multi-layer-coding in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some aspects, the transceiver 1110 may include a wired transceiver and may communicate bi-directionally with another wired transceiver. Additionally, or alternatively, In some aspects, the transceiver 1110 may include a wireless transceiver and may communicate bi-directionally with another wireless transceiver. In some aspects, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some aspects, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some aspects, the at least one processor 1135 may include multiple processors and the at least one memory 1125 may include multiple memories. One or more of the multiple processors may be coupled with one or more of the multiple memories which may, individually or collectively, be configured to perform various functions herein (In one aspect, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting a channel aware per layer report for MIMO multi-layer-coding). In one aspect, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some aspects, the at least one processor 1135 may include multiple processors and the at least one memory 1125 may include multiple memories. One or more of the multiple processors may be coupled with one or more of the multiple memories, which may, individually or collectively, be configured to perform various functions herein. In some aspects, the at least one processor 1135 may be a component of a processing system, which may refer to a system (such as a series) of machines, circuitry (including, In one aspect, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. In one aspect, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some aspects, a bus 1140 may support communications of (e.g., within) a protocol layer of a protocol stack. In some aspects, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some aspects, the communications manager 1120 may manage aspects of communications with a core network 130 (e.g., via one or more wired or wireless backhaul links). In one aspect, the communications manager 1120 may manage the transfer of data communications for client devices, such as one or more UEs 115. In some aspects, the communications manager 1120 may manage communications with one or more other network entities 105, and may include a controller or scheduler for controlling communications with UEs 115 (e.g., in cooperation with the one or more other network devices). In some aspects, the communications manager 1120 may support an X2 interface within an LTE/LTE-A wireless communications network technology to provide communication between network entities 105.

The communications manager 1120 may support wireless communication implemented in accordance with examples as disclosed herein. In one aspect, the communications manager 1120 is capable of, configured to, or operable to support a means for receiving a capability message, the capability message including an indication of a UE capability for per-layer codeword mapping and a channel state feedback (CSF) report option. The communications manager 1120 is capable of, configured to, or operable to support a means for transmitting a CSF configuration that includes an indication of a CSF report type, where the CSF report type is a wideband report, a sub-band report, or a combination thereof. The communications manager 1120 is capable of, configured to, or operable to support a means for receiving a CSF report in accordance with the CSF report option and the CSF report type, the CSF report contingent on the UE capability for per-layer codeword mapping and including information associated with per layer mutual information (MI).

By including or configuring the communications manager 1120 in accordance with examples as described herein, the device 1105 may support techniques for enabling a per layer MI report to support improved communication reliability, reduced latency, improved user experience related to reduced processing, reduced power consumption, more efficient utilization of communication resources, improved coordination between devices, longer battery life, and improved utilization of processing capability.

In some aspects, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, In some aspects, one or more functions described with reference to the communications manager 1120 may be supported by or performed by the transceiver 1110, one or more of the at least one processor 1135, one or more of the at least one memory 1125, the code 1130, or any combination thereof (In one aspect, by a processing system including at least a portion of the at least one processor 1135, the at least one memory 1125, the code 1130, or any combination thereof). In one aspect, the code 1130 may include instructions executable by one or more of the at least one processor 1135 to cause the device 1105 to perform various aspects of a channel aware per layer report for MIMO multi-layer-coding as described herein, or the at least one processor 1135 and the at least one memory 1125 may be otherwise configured to, individually or collectively, perform or support such operations.

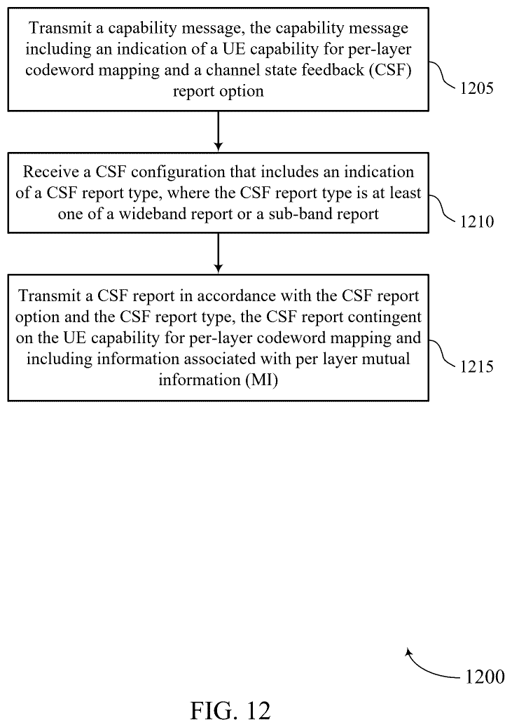

FIG. 12 shows a flowchart illustrating a method 1200 that supports a channel aware per layer report for MIMO multi-layer-coding in accordance with one or more aspects of the present disclosure. The operations of the method 1200 may be implemented by a UE or its components as described herein. In one aspect, the operations of the method 1200 may be performed by a UE 115 as described with reference to FIGS. 1 through 7. In some aspects, a UE may execute a set of instructions to control the functional elements of the UE to perform the described functions. Additionally, or alternatively, the UE may perform aspects of the described functions using special-purpose hardware.

At 1205, the method may include transmitting a capability message, the capability message including an indication of a UE capability for per-layer codeword mapping and a channel state feedback (CSF) report option. The operations of 1205 may be performed in accordance with examples as disclosed herein. In some aspects, aspects of the operations of 1205 may be performed by a capability message transmitter 625 as described with reference to FIG. 6.

At 1210, the method may include receiving a CSF configuration that includes an indication of a CSF report type, where the CSF report type is a wideband report, a sub-band report, or a combination thereof. The operations of 1210 may be performed in accordance with examples as disclosed herein. In some aspects, aspects of the operations of 1210 may be performed by an CSF configuration receiver 630 as described with reference to FIG. 6.

At 1215, the method may include transmitting a CSF report in accordance with the CSF report option and the CSF report type, the CSF report contingent on the UE capability for per-layer codeword mapping and including information associated with per layer mutual information (MI). The operations of 1215 may be performed in accordance with examples as disclosed herein. In some aspects, aspects of the operations of 1215 may be performed by an CSF report transmitter 635 as described with reference to FIG. 6.

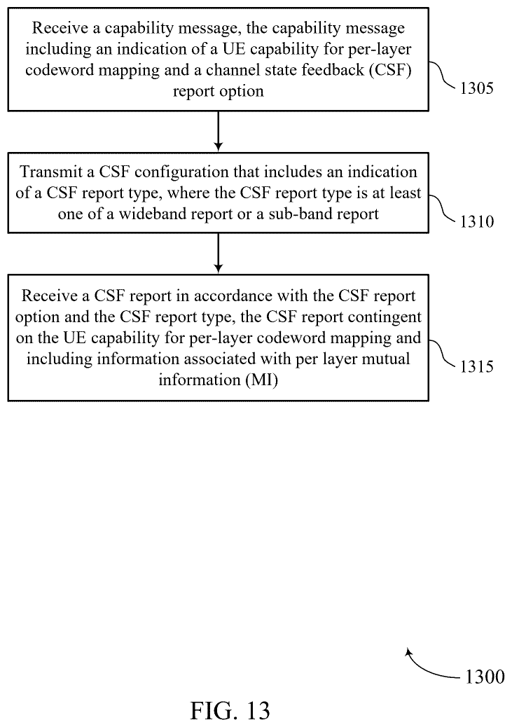

FIG. 13 shows a flowchart illustrating a method 1300 that supports a channel aware per layer report for MIMO multi-layer-coding in accordance with one or more aspects of the present disclosure. The operations of the method 1300 may be implemented by a network entity or its components as described herein. In one aspect, the operations of the method 1300 may be performed by a network entity as described with reference to FIGS. 1 through 3 and 8 through 11. In some aspects, a network entity may execute a set of instructions to control the functional elements of the network entity to perform the described functions. Additionally, or alternatively, the network entity may perform aspects of the described functions using special-purpose hardware.

At 1305, the method may include receiving a capability message, the capability message including an indication of a UE capability for per-layer codeword mapping and a channel state feedback (CSF) report option. The operations of 1305 may be performed in accordance with examples as disclosed herein. In some aspects, aspects of the operations of 1305 may be performed by a capability message receiver 1025 as described with reference to FIG. 10.

At 1310, the method may include transmitting a CSF configuration that includes an indication of a CSF report type, where the CSF report type is a wideband report, a sub-band report, or a combination thereof. The operations of 1310 may be performed in accordance with examples as disclosed herein. In some aspects, aspects of the operations of 1310 may be performed by an CSF configuration transmitter 1030 as described with reference to FIG. 10.

At 1315, the method may include receiving a CSF report in accordance with the CSF report option and the CSF report type, the CSF report contingent on the UE capability for per-layer codeword mapping and including information associated with per layer mutual information (MI). The operations of 1315 may be performed in accordance with examples as disclosed herein. In some aspects, aspects of the operations of 1315 may be performed by an CSF report receiver 1035 as described with reference to FIG. 10.

The following provides an overview of aspects of the present disclosure:

Aspect 1: A method for wireless communication implemented by a UE, comprising: transmitting a capability message, the capability message comprising an indication of a UE capability for per-layer codeword mapping and a CSF report option; receiving a CSF configuration that includes an indication of a CSF report type, wherein the CSF report type is a wideband report, a sub-band report, or a combination thereof; transmitting a CSF report in accordance with the CSF report option and the CSF report type, the CSF report contingent on the UE capability for per-layer codeword mapping and comprising information associated with per layer MI.

Aspect 2: The method of aspect 1, wherein the CSF report comprises an average per layer MI in accordance with the CSF report option.

Aspect 3: The method of aspect 2, further comprising: receiving a DCI that indicates a code rate per layer based at least in part on the average per layer MI included in the CSF report.

Aspect 4: The method of any of aspects 1 through 3, wherein the CSF report comprises code rate per layer information that corresponds to the per layer MI in accordance with the CSF report option.

Aspect 5: The method of aspect 4, wherein the code rate per layer information includes a MCS that is reported in the CSF and that is based on the per layer MI.

Aspect 6: The method of any of aspects 4 through 5, further comprising: receiving a DCI that indicates a code rate per layer based at least in part on the code rate per layer information included in the CSF report.

Aspect 7: The method of any of aspects 1 through 6, wherein the CSF report is initialized with a default per layer MI value.

Aspect 8: The method of aspect 7, further comprising: calculating an average per layer MI over a slot; determining an average per layer MI calculation based at least in part on an average of the average per layer MI over the slot, wherein the CSF report is based at least in part on the average per layer MI calculation.

Aspect 9: The method of any of aspects 1 through 8, wherein the wideband report comprises a wideband per layer MI report, and the sub-band report comprises a sub-band per layer MI report.

Aspect 10: The method of any of aspects 1 through 9, wherein the CSF configuration includes an indication of a CSF report periodicity, and the CSF report is transmitted in accordance with the CSF report periodicity.

Aspect 11: The method of any of aspects 1 through 10, further comprising: receiving an acknowledgment message based at least in part on the capability message; and performing a radio resource control procedure based at least in part on the acknowledgment message.

Aspect 12: A method for wireless communication implemented by a network entity, comprising: receiving a capability message, the capability message comprising an indication of a UE capability for per-layer codeword mapping and a CSF report option; transmitting a CSF configuration that includes an indication of a CSF report type, wherein the CSF report type is a wideband report, a sub-band report, or a combination thereof; receiving a CSF report in accordance with the CSF report option and the CSF report type, the CSF report contingent on the UE capability for per-layer codeword mapping and comprising information associated with per layer MI.

Aspect 13: The method of aspect 12, wherein the CSF report comprises an average per layer MI in accordance with the CSF report option.

Aspect 14: The method of aspect 13, further comprising: transmitting a DCI that indicates a code rate per layer based at least in part on the average per layer MI included in the CSF report.

Aspect 15: The method of any of aspects 12 through 14, wherein the CSF report comprises code rate per layer information that corresponds to the per layer MI in accordance with the CSF report option.

Aspect 16: The method of aspect 15, wherein the code rate per layer information includes a MCS that is reported in the CSF and that is based on the per layer MI.

Aspect 17: The method of any of aspects 15 through 16, further comprising: transmitting a DCI that indicates a code rate per layer based at least in part on the code rate per layer information included in the CSF report.

Aspect 18: The method of any of aspects 12 through 17, wherein the CSF report is initialized with a default per layer MI value.

Aspect 19: The method of aspect 18, wherein the CSF report is based at least in part on an average per layer MI calculation determined from an average of an average per layer MI over a slot.

Aspect 20: The method of any of aspects 12 through 19, wherein the wideband report comprises a wideband per layer MI report, and the sub-band report comprises a sub-band per layer MI report.

Aspect 21: The method of any of aspects 12 through 20, wherein the CSF configuration includes an indication of a CSF report periodicity, and the CSF report is transmitted in accordance with the CSF report periodicity.

Aspect 22: The method of any of aspects 12 through 21, further comprising: transmitting an acknowledgment message based at least in part on the capability message; and performing a radio resource control procedure based at least in part on the acknowledgment message.

Aspect 23: A UE for wireless communication implemented, comprising one or more memories storing processor-executable code, and one or more processors coupled with the one or more memories and individually or collectively operable to execute the code to cause the UE to perform a method of any of aspects 1 through 11.

Aspect 24: A UE for wireless communication implemented, comprising at least one means for performing a method of any of aspects 1 through 11.

Aspect 25: A non-transitory computer-readable medium storing code for wireless communication implemented, the code comprising instructions executable by one or more processors to perform a method of any of aspects 1 through 11.

Aspect 26: A network entity for wireless communication implemented, comprising one or more memories storing processor-executable code, and one or more processors coupled with the one or more memories and individually or collectively operable to execute the code to cause the network entity to perform a method of any of aspects 12 through 22.

Aspect 27: A network entity for wireless communication implemented, comprising at least one means for performing a method of any of aspects 12 through 22.

Aspect 28: A non-transitory computer-readable medium storing code for wireless communication implemented, the code comprising instructions executable by one or more processors to perform a method of any of aspects 12 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. In one aspect, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. In one aspect, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. In one aspect, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. In one aspect, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, In one aspect, a list of at least one of A, B, or C means A or B or C or AB or AC or BC or ABC (i.e., A and B and C). Also, as used herein, the phrase “based on” shall not be construed as a reference to a closed set of conditions. In one aspect, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. In one aspect, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. In one aspect, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. In one aspect, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability message, the capability message comprising an indication of a UE capability for per-layer codeword mapping and a channel state feedback (CSF) report option;
receive a CSF configuration that includes an indication of a CSF report type, wherein the CSF report type is a wideband report, a sub-band report, or a combination thereof;
transmit a CSF report in accordance with the CSF report option and the CSF report type, the CSF report contingent on the UE capability for per-layer codeword mapping and comprising information associated with per layer mutual information (MI).

2. The UE of claim 1, wherein the CSF report comprises an average per layer MI in accordance with the CSF report option.

3. The UE of claim 2, wherein the one or more processors are individually or collectively further operable to execute the code to cause the UE to:
receive a downlink control information (DCI) that indicates a code rate per layer based at least in part on the average per layer MI included in the CSF report.

4. The UE of claim 1, wherein the CSF report comprises code rate per layer information that corresponds to the per layer MI in accordance with the CSF report option.

5. The UE of claim 4, wherein the code rate per layer information includes a modulation and coding scheme that is reported in the CSF report and that is based on the per layer MI.

6. The UE of claim 4, wherein the one or more processors are individually or collectively further operable to execute the code to cause the UE to:
receive a downlink control information (DCI) that indicates a code rate per layer based at least in part on the code rate per layer information included in the CSF report.

7. The UE of claim 1, wherein the CSF report is initialized with a default per layer MI value.

8. The UE of claim 7, wherein the one or more processors are individually or collectively further operable to execute the code to cause the UE to:
calculate an average per layer MI over a slot;
determine an average per layer MI calculation based at least in part on an average of the average per layer MI over the slot, wherein the CSF report is based at least in part on the average per layer MI calculation.

9. The UE of claim 1, wherein:
the wideband report comprises a wideband per layer MI report, and
the sub-band report comprises a sub-band per layer MI report.

10. The UE of claim 1, wherein:
the CSF configuration includes an indication of a CSF report periodicity, and
the CSF report is transmitted in accordance with the CSF report periodicity.

11. The UE of claim 1, wherein the one or more processors are individually or collectively further operable to execute the code to cause the UE to:
receive an acknowledgment message based at least in part on the capability message; and
perform a radio resource control procedure based at least in part on the acknowledgment message.

12. A network entity, comprising:
one or more memories storing processor-executable code; and
one or more processors coupled with the one or more memories and individually or collectively operable to execute the code to cause the network entity to:
receive a capability message, the capability message comprising an indication of a user equipment (UE) capability for per-layer codeword mapping and a channel state feedback (CSF) report option;
transmit a CSF configuration that includes an indication of a CSF report type, wherein the CSF report type is a wideband report, a sub-band report, or a combination thereof;
receive a CSF report in accordance with the CSF report option and the CSF report type, the CSF report contingent on the UE capability for per-layer codeword mapping and comprising information associated with per layer mutual information (MI).

13. The network entity of claim 12, wherein the CSF report comprises an average per layer MI in accordance with the CSF report option.

14. The network entity of claim 13, wherein the one or more processors are individually or collectively further operable to execute the code to cause the network entity to:
transmit a downlink control information (DCI) that indicates a code rate per layer based at least in part on the average per layer MI included in the CSF report.

15. The network entity of claim 12, wherein the CSF report comprises code rate per layer information that corresponds to the per layer MI in accordance with the CSF report option.

16. The network entity of claim 15, wherein the code rate per layer information includes a modulation and coding scheme that is reported in the CSF report and that is based on the per layer MI.

17. The network entity of claim 15, wherein the one or more processors are individually or collectively further operable to execute the code to cause the network entity to:
transmit a downlink control information (DCI) that indicates a code rate per layer based at least in part on the code rate per layer information included in the CSF report.

18. The network entity of claim 12, wherein the CSF report is initialized with a default per layer MI value.

19. The network entity of claim 18, wherein the CSF report is based at least in part on an average per layer MI calculation determined from an average of an average per layer MI over a slot.

20. The network entity of claim 12, wherein:
the wideband report comprises a wideband per layer MI report, and
the sub-band report comprises a sub-band per layer MI report.

21. The network entity of claim 12, wherein:
the CSF configuration includes an indication of a CSF report periodicity, and
the CSF report is transmitted in accordance with the CSF report periodicity.

22. The network entity of claim 12, wherein the one or more processors are individually or collectively further operable to execute the code to cause the network entity to:
transmit an acknowledgment message based at least in part on the capability message; and
perform a radio resource control procedure based at least in part on the acknowledgment message.

23. A method for wireless communication implemented by a user equipment (UE), comprising:
transmitting a capability message, the capability message comprising an indication of a UE capability for per-layer codeword mapping and a channel state feedback (CSF) report option;
receiving a CSF configuration that includes an indication of a CSF report type, wherein the CSF report type is a wideband report, a sub-band report, or a combination thereof;
transmitting a CSF report in accordance with the CSF report option and the CSF report type, the CSF report contingent on the UE capability for per-layer codeword mapping and comprising information associated with per layer mutual information (MI).

24. The method of claim 23, wherein the CSF report comprises code rate per layer information that corresponds to the per layer MI in accordance with the CSF report option.

25. The method of claim 23, wherein the CSF report is initialized with a default per layer MI value.

26. The method of claim 25, further comprising:
calculating an average per layer MI over a slot;
determining an average per layer MI calculation based at least in part on an average of the average per layer MI over the slot, wherein the CSF report is based at least in part on the average per layer MI calculation.

27. A method for wireless communication implemented by a network entity, comprising:
receiving a capability message, the capability message comprising an indication of a user equipment (UE) capability for per-layer codeword mapping and a channel state feedback (CSF) report option;
transmitting a CSF configuration that includes an indication of a CSF report type, wherein the CSF report type is a wideband report, a sub-band report, or a combination thereof;
receiving a CSF report in accordance with the CSF report option and the CSF report type, the CSF report contingent on the UE capability for per-layer codeword mapping and comprising information associated with per layer mutual information (MI).

28. The method of claim 27, wherein the CSF report comprises an average per layer MI in accordance with the CSF report option.

29. The method of claim 28, further comprising:
transmitting a downlink control information (DCI) that indicates a code rate per layer based at least in part on the average per layer MI included in the CSF report.

30. The method of claim 27, wherein the CSF report comprises code rate per layer information that corresponds to the per layer MI in accordance with the CSF report option.
